(19) United States
(12) Patent Application Publication
(10) Pub. No.: US 2016/0334084 A1
(43) Pub. Date: Nov. 17, 2016

(54) INTERCHANGEABLE ADAPTER FOR CHANGING LED LIGHT BULBS

(71) Applicant: GR Ventures L.L.C., Northfield, NJ (US)

(72) Inventor: JOSEPH GURWICZ, Egg Harbor Twp, NJ (US)

(21) Appl. No.: 15/179,517

(22) Filed: Jun. 10, 2016

Related U.S. Application Data
(63) Continuation-in-part of application No. 15/130,618, filed on Apr. 15, 2016.
Application No. 15/130,618 is a continuation-in-part of application No. 15/050,021, filed on Feb. 22, 2016.
Application No. 15/050,021 is a continuation-in-part of application No. 14/457,871, filed on Aug. 12, 2014.
(60) Provisional application No. 61/987,175, filed on May 1, 2014.

(51) Int. Cl. F21V 19/04; F21V 29/77; F21K 99/00

(52) U.S. Cl. CPC F21V 19/042; F21K 9/135; F21V 29/77; F21Y 2101/02

(57) ABSTRACT

An interchangeable adapter for changing a light bulb that includes a head piece that has a base plate with opposite first and second sides and that defines a platform at the first side. A gripping member extends from the platform of the first side of the base plate away from the second side. The gripping member is positioned substantially centrally with respect to the platform to engage the light bulb. At least one release member links the base plate and the gripping member wherein movement of the base plate actuates the release member. An engagement member extends from the second side of the base plate away from the first side for engaging a holder of the adapter.

### REFERENCE TO RELATED APPLICATIONS

The present application is a continuation-in-part of and claims the benefit of U.S. patent application Ser. No. 15/130,618, filed Apr. 15, 2016, which is a continuation-in-part of U.S. patent application Ser. No. 15/050,021, filed Feb. 22, 2016, which is a continuation-in-part of U.S. patent application Ser. No. 14/457,871 filed Aug. 12, 2014, which claims the benefit of U.S. Provisional Patent Application No. 61/987,175, filed May 1, 2014, the disclosures of which are hereby incorporated in their entirety into the present disclosure.

### FIELD OF THE INVENTION

The present invention is directed to an interchangeable adapter for changing light bulbs and more particularly to an interchangeable adapter for changing LED (light-emitting diode) light bulbs.

### DESCRIPTION OF RELATED ART

Light-bulb changers are known in the art and allow a user to change a light bulb without using a step ladder or touching a hot bulb. A typical changer comprises a grabber for grabbing a light bulb, attached to a pole for allowing a user to reach the light bulb with the grabber. The grabber includes flexible fingers for engaging the light bulb and allowing the user to unscrew the light bulb. A changer can be sold with multiple grabbers for different sizes and shapes of light bulbs, each of them removably attachable to the pole with a threaded connection. The grabbers are designed for use with roughly spherical incandescent light bulbs, spotlight bulbs, and compact fluorescent light (CFL) bulbs.

In an unrelated development, LED light bulbs are increasingly popular, at least in part because of federal regulations. A typical LED light bulb, which can be designed to fit into the same socket as a traditional incandescent light bulb, is shown in FIGS. 1-3 as 100. The light bulb 100 includes a heat sink 102 of aluminum or a similar material around the lighting element. The heat sink has multiple cooling fins 104 (omitted from FIG. 1 for clarity, but shown in FIGS. 2 and 3) radiating from the axis A of the bulb 100; in many designs, the fins 104 extend to the front of the bulb 100 and are supported by a ring 106. The fins 104 define spaces 108 therebetween.

However, LED light bulbs are typically shaped differently from conventional incandescent, halogen, or compact fluorescent light bulbs. For example, the bulb 100 of FIGS. 1-3 has a flat face and a sharply sloping back. As a consequence, traditional changers do not work with many LED light bulbs. Because of the different shape, the flexible fingers of the grabber often cannot engage with the bulb, nor can they enter the spaces 108. The LED light bulbs may also be of different diameters, such as the PAR 30 and PAR 38.

### SUMMARY OF THE INVENTION

It is therefore an object of the invention to provide a light-bulb changer for changing LED light bulbs.

To achieve the above and other objects, the present invention is directed to an adapter for changing LED light bulbs. The adapter can have a threaded fitting for attachment to the pole of an existing light-bulb changer. The adapter has a body, preferably formed of a rigid material such as a rigid plastic. The body has multiple teeth to engage the spaces between the cooling fins of the LED light bulb. The light bulb can then be unscrewed from its socket and lowered using the pole and the adapter. A new light bulb can be placed on the teeth, raised, and screwed into the socket.

The adapter can be designed for each type of LED light bulb and for the pole to which it is to be attached. The adapter has the correct number of teeth, and the correct length of each tooth, to engage the light bulb for removal. The teeth typically face directly forward, parallel to the axis of the adapter, to allow easy insertion of the teeth into the spaces and easy removal once the light bulb has been lowered from its socket. The adapter is also designed to attach to the pole; as a result, the adapter can have a conical, hemispherical, or similar shape.

Multiple such adapters can be sold together as a kit for changing multiple types of light bulbs. An adapter can be sold with a pole, with screw adapters for mounting on different types of poles, or separately.

The present invention also provides a head piece for an adapter for changing a light bulb that includes a base plate that has opposite first and second sides, and a perimeter defined between first and second sides, and the base plate defines a platform at the first side. A plurality of teeth extend from the platform of the first side of the base plate away from the second side. The plurality of teeth are spaced and arranged on the platform to engage the light bulb. An engagement member extends from the second surface of the base plate away from the first side for engaging a holder of the adapter.

The present invention further provides an interchangeable adapter for changing a light bulb that includes a holder that has a mounting end and an interface end opposite the mounting end, and a first engagement member disposed inside of the holder. At least one head piece that is separate from the holder is releasably coupled thereto at the interface end of the holder. The head piece has a base plate with opposite first and second sides, and the first side defines a platform. A plurality of teeth extend from the platform of the first side of the base plate. The plurality of teeth are spaced and arranged on the platform to engage the light bulb. A second engagement member extends from the second side of the base plate for engaging the first engagement member of the holder.

The present invention yet further provides a method for changing a light bulb that includes the steps of providing a holder of an adapter for changing the light bulb, the holder having a mounting end and an interface end opposite the mounting end, and a first engagement member disposed inside of the holder; providing a plurality of head pieces, each of the head pieces having, a base plate with opposite first and second sides, the first side defining a platform, a plurality of teeth extending from the platform of the first side of the base plate, the plurality of teeth being spaced and arranged on the platform to engage the light bulb, and a second engagement member extending from the second side of the base plate for releasably engaging the first engagement member of the holder; selecting one of the plurality of head pieces; and coupling the selected one of the plurality of head pieces with the interface end of the holder by releasably coupling the first and second engagement members.

The present invention may still further provide a headpiece for an interchangeable adapter for changing a light bulb that includes a base plate with opposite first and second sides and that defines a platform at the first side. A primary gripping member extends from the platform of the first side of the base plate away from the second side. The primary gripping member is positioned substantially centrally with respect to the platform to engage the light bulb. A secondary gripping member extends from the platform of the first side of the base plate away from the second side. The secondary gripping member surrounds the primary gripping member and is configured to grip the light bulb. An engagement member extends from the second side of the base plate away from the first side for engaging a holder of the adapter. In a preferred embodiment, the primary gripping member is a suction cup.

The present invention may further provide an interchangeable adapter for changing a light bulb that includes a holder that has a mounting end and an interface end opposite the mounting end and a first engagement member disposed inside of the holder. At least one head piece that is separate from the holder and releasably coupled thereto at the interface end of the holder. The head piece includes a base plate that has opposite first and second sides and defines a platform at the first side. A primary gripping member extends from the platform of the first side of the base plate away from the second side. The primary gripping member is positioned substantially centrally with respect to the platform to engage the light bulb. A secondary gripping member extends from the platform of the first side of the base plate away from the second side. The secondary gripping member surrounds the primary gripping member and is configured to grip the light bulb. A second engagement member extends from the second side of the base plate away from the first side for engaging the first engagement member of the holder.

The present invention may yet further provide a method for changing a light bulb, including the steps of providing an adapter having a holder and a head piece releasably mounted thereto, the head piece including a base plate having opposite first and second sides, the base plate defining a platform at the first side, a primary gripping member extending from the platform of the first side of the base plate away from the second side, the primary gripping member being positioned substantially centrally with respect to the platform, and a secondary gripping member extending from the platform of the first side of the base plate away from the second side, the secondary gripping member surrounding the primary gripping member; gripping the light bulb with the primary gripping member of the adapter; and subsequent to gripping the light bulb with the primary gripping member, moving the adapter toward the light bulb until the secondary gripping member grips the light bulb.

The present invention may also provide a head piece for an adapter for changing a light bulb, that includes a base plate having opposite first and second sides and defining a platform at the first side, and a gripping member that extends from the platform of the first side of the base plate away from the second side, the gripping member may be positioned substantially centrally with respect to the platform to engage the light bulb. At least one release member links the base plate and the gripping member. An engagement member extends from the second side of the base plate away from the first side for engaging a holder of the adapter, wherein movement of the base plate actuates the release member.

The present invention may further provide an interchangeable adapter for changing a light bulb that includes a holder that has a mounting end and an interface end opposite the mounting end, a first engagement member disposed inside of the holder, and at least one head piece separate from the holder and releasably coupled thereto at the interface end of the holder. The head piece includes a base plate that has opposite first and second sides and defines a platform at the first side. A gripping member extends from the platform of the first side of the base plate away from the second side. The gripping member may be positioned substantially centrally with respect to the platform to engage the light bulb. At least one release member links the base plate and the gripping member, wherein movement of the base plate actuates the release member to release the grip on the light bulb. A second engagement member extends from the second side of the base plate away from the first side for engaging said first engagement member of said holder.

The present invention may yet further provide a method for changing a light bulb, comprising the steps of providing an adapter having a holder and a head piece releasably mounted thereto, the head piece including a base plate having opposite first and second sides, the base plate defining a platform at said first side, a gripping member extending from the platform of the first side of the base plate away from said second side, the gripping member being positioned substantially centrally with respect to the platform, and at least one release member linking the base plate and the gripping member; gripping the light bulb with the gripping member of the adapter; and subsequent to gripping the light bulb with the gripping member, releasing the grip of the gripping member on the light bulb by actuating the at least one release member.

### BRIEF DESCRIPTION OF THE DRAWINGS

Preferred embodiments of the invention will be set forth in detail with reference to the drawings, in which:

FIG. 1 is a perspective view showing the adapter according to the preferred embodiment being brought into engagement with a light bulb;

FIG. 2 is a view showing the interrelations among the parts of the adapter and light bulb of FIG. 1;

FIG. 3 is a side view showing the adapter and light bulb of FIG. 1 when they are engaged with each other;

FIG. 4 is a perspective view showing a set of three adapters sized for different light bulbs according to a variation of the preferred embodiment;

FIG. 5 is a top perspective view of an interchangeable adapter in accordance with an alternative embodiment of the present invention, showing a holder and a selected head piece of the adapter;

FIG. 6 is a cross-sectional view of the interchangeable adapter illustrated in FIG. 5;

FIG. 7 is a top perspective view of the holder of the interchangeable adapter illustrated in FIG. 5;

FIGS. 8A and 8B are top perspective and cross-sectional views, respectively, of a head piece of the interchangeable adapter in accordance with an exemplary embodiment of the present invention;

FIGS. 9A and 9B are top perspective and cross-sectional views, respectively, of a head piece of the interchangeable adapter in accordance with another exemplary embodiment of the present invention;

FIGS. 10A and 10B are top perspective and cross-sectional views, respectively, of a head piece of the interchangeable adapter in accordance with still another exemplary embodiment of the present invention;

FIGS. 11A and 11B are top perspective and cross-sectional views, respectively, of a head piece of the interchangeable adapter in accordance with yet another exemplary embodiment of the present invention;

FIG. 12 is a perspective view of a head piece of the interchangeable adapter in accordance with still yet another exemplary embodiment of the present invention, showing the head piece mounted on the holder of the adapter;

FIG. 13 is a side elevational view of the head piece illustrated in FIG. 12;

FIG. 14 is a cross-sectional view of the head piece illustrated in FIG. 12, taken along line 14-14 of FIG. 13;

FIG. 15 is a perspective view of a head piece of the interchangeable adapter in accordance with still yet a further exemplary embodiment of the present invention;

FIG. 16 is another perspective view of the head piece illustrated in FIG. 15;

FIG. 17 is a cross-sectional view of the head piece illustrated in FIG. 15;

FIG. 18 is a cross-sectional view of a gripping member of the head piece illustrated in FIG. 15; and

FIG. 19 is a perspective view of a release member of the head piece illustrated in FIG. 15.

### DETAILED DESCRIPTION OF THE PREFERRED EMBODIMENTS

Preferred embodiments of the invention will be described in detail with reference to the drawings, in which like reference numerals refer to like elements or steps throughout.

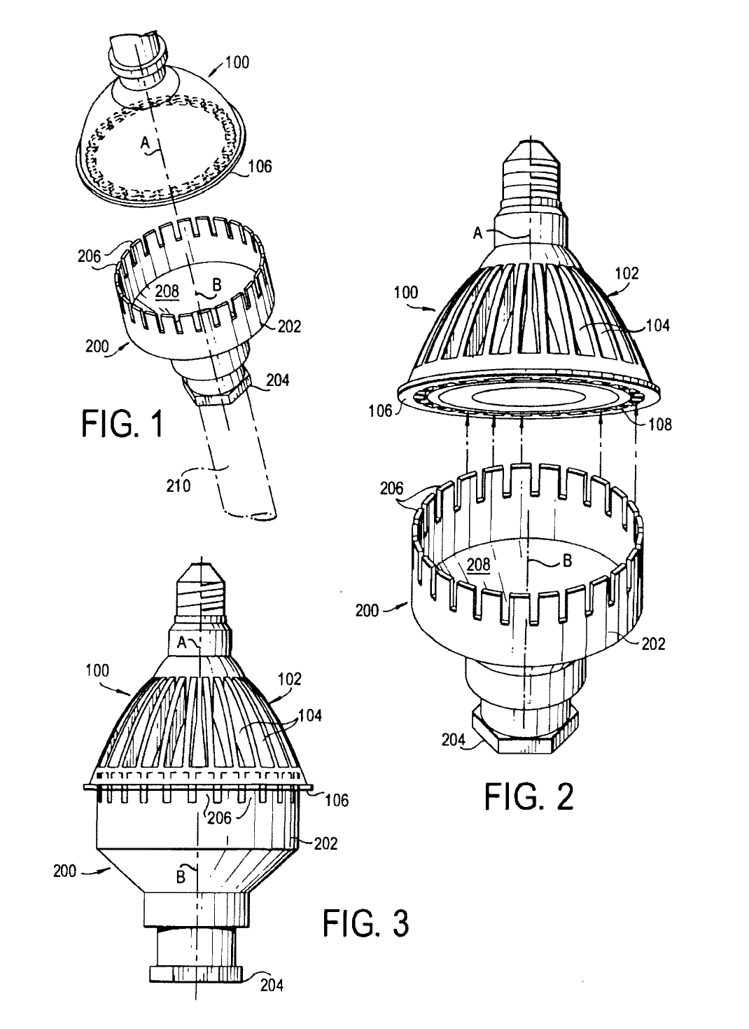

FIGS. 1-3 show an adapter 200 according to a preferred embodiment. Because the adapter is designed to be used with a particular light bulb, its proportions, including its diameter and the number and length of teeth, are selected for that particular light bulb.

The adapter 200 has a body 202. At one end of the body 202 is a mount 204, such as a threaded mount, designed to mount the adapter 200 onto the pole 210 of a light-bulb changer, which can be a light-bulb changer now on the market or yet to be introduced. At the other end are teeth 206 for engaging with the light bulb in a manner to be explained below. The teeth 206 extend parallel to the axis B of the adapter 200 for easy engagement and disengagement with the light bulb. Because the end with the mount 204 and the end with the teeth 206 typically have different diameters, the body 202 has a shape, such as a cone or a hemisphere, although any other suitable shape can be chosen.

The adapter 200 can be made in any suitable way, such as by molding or by machining, and out of any suitable material, such as rigid plastic. It is contemplated that the body 202 will have an empty space 208 to reduce both the weight of the adapter 200 and the amount of material used; however, the body 202 could be solid if so desired.

FIG. 3 shows the engagement of the light bulb 100 and the adapter 200. The light bulb 100 and the adapter 200 are brought into a coaxial arrangement facing each other, and the teeth 206 are inserted into the spaces 108. By turning the adapter 200 (e.g., by turning the pole), the user turns the light bulb 100 to screw it into or unscrew it from the socket. Once the light bulb 100 is screwed in, the adapter 200 can simply be lowered, or once the light bulb 100 is unscrewed and lowered, it can simply be taken off of the adapter. As the light bulb 100 is raised or lowered, the body 202 and the teeth 206 support the light bulb 100 against falling off of the adapter 200.

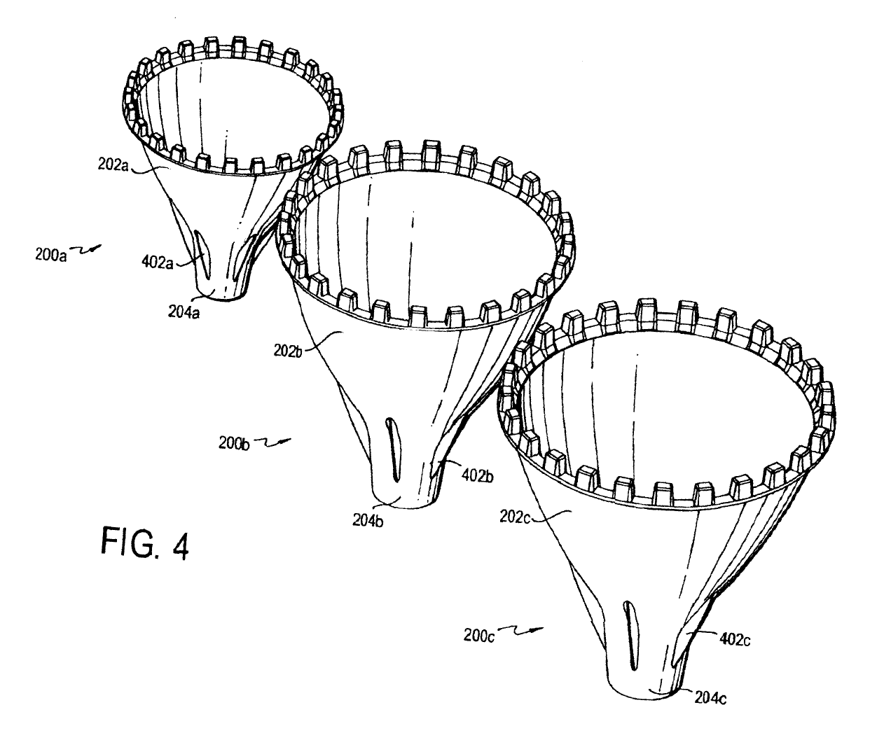

FIG. 4 is a perspective view showing three adapters 200a, 200b, 200c according to a variation of the preferred embodiment. The three adapters 200a, 200b, 200c are sized for different light bulbs. Of course, they can be packaged together or sold separately.

Each adapter 200a, 200b, 200c has a body 202a, 202b, 202c having curved sides. Ribs 402a, 402b, 402c are formed between the body 202a, 202b, 202c and the mount 204a, 204b, 204c. Otherwise, the adapters 200a, 200b, 200c can be formed like the adapter 200 of FIGS. 1-3.

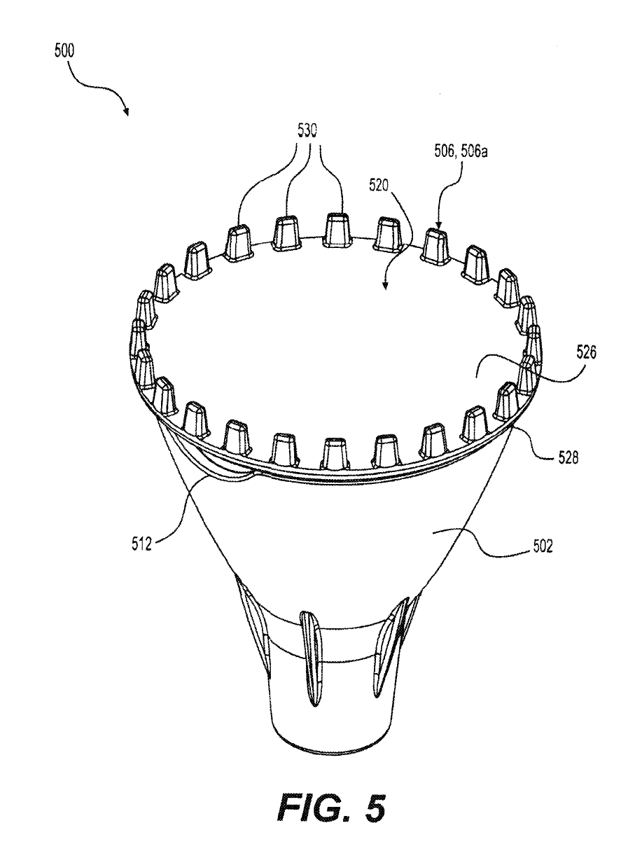

FIGS. 5-7 illustrate an alternative embodiment of the present invention of an interchangeable adapter 500 which allows the user to customize the adapter to the particular type and size of the LED light bulb. The interchangeable adapter 500 generally includes a holder 502 and a head piece 506 that fits onto the holder 502, where the head piece may be selected from a plurality of different head pieces, such as head pieces 506a, 506b, 506c, 506d, and 506e, shown in FIGS. 5, 6, 8A, 8B, 9A, 9B, 10A, 10B, 11A, and 11B, respectively. The holder 502 and the head pieces 506a, 506b, 506c, 506d, and 506e are preferably formed of a rigid or semi rigid plastic.

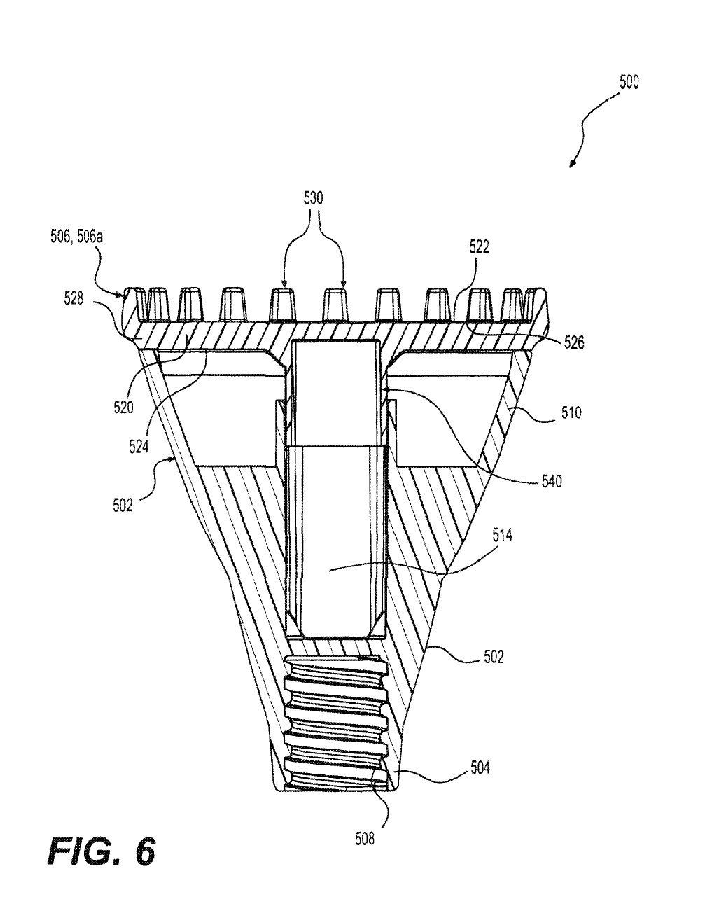

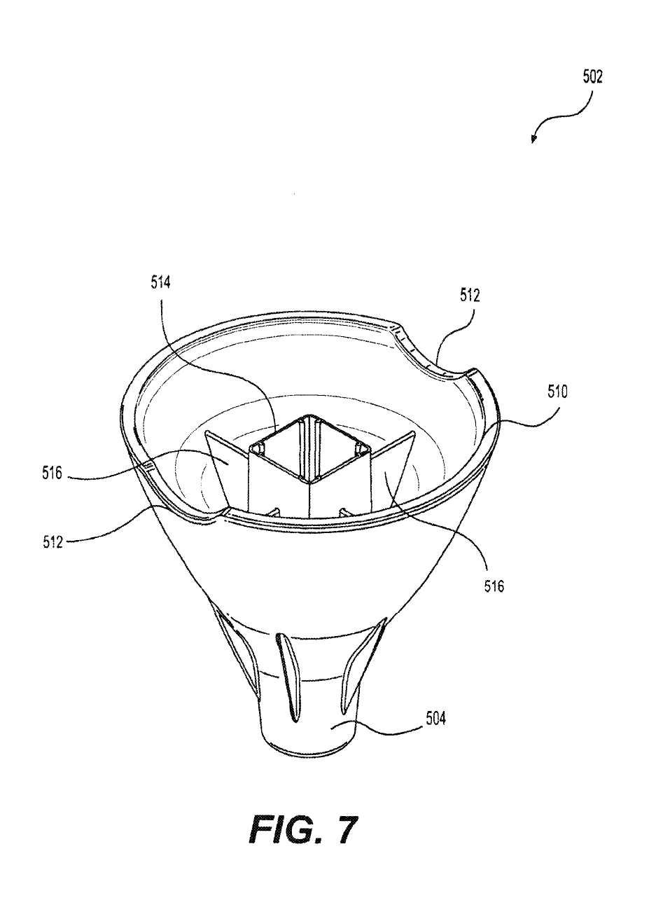

As seen in FIG. 7, the holder 502 generally includes a body that has a mounting end 504 adapted to receive an extension or pole to assist the user in reaching the light bulb. The mounting end 504 may have internal threads 508, for example, for engaging the pole. Opposite the mounting end 504 is an interface end 510 that interfaces with and engages with the selected head piece 506. The holder 502 may be substantially cone shaped such that the diameter of its interface end 510 is larger than the mounting end 504. The edge of the interface end 510 may include one or more semi-circular cutouts 512 sized to accommodate a person's finger to assist in removal and replacement of the selected head piece 506. In a preferred embodiment, two cutouts 512 are provided that are disposed opposite one another at the interface end 510. The inside of the holder 502 includes an engagement member 514 configured to engage a corresponding member of the selected head piece 506. The engagement member 514 may be an elongated stem centrally disposed inside of the holder 502, as best seen in FIGS. 6 and 7. One or more strength members 516, such as radial fins, may be provided that extend between the engagement member 514 and the inner wall surface of the holder's body to add rigidity to the inside of the holder 502. The holder 502 may be formed as a one-piece member, or the components may be formed separately and integrally attached.

FIGS. 5 and 6 illustrate a first exemplary embodiment of a selected head piece 506a. The head piece 506a generally includes a base plate 520 with first and second opposite sides 522 and 524, a plurality of teeth 530 adapted to engage the light bulb that extend from the first side 522, and an engagement member 540 adapted to engage the holder 502 that extends from the second side. In a preferred embodiment, the base plate 520 is substantially circular and defines a platform 526 that supports the plurality of teeth 530. As seen in FIG. 6, the platform 526 has a diameter that is at least the same as the holder's interface end 510, and preferably slightly larger than the interface end 510. The teeth 530 are arranged on the platform 526 to engage the spaces of the light bulb requiring changes, such as spaces 108 (FIG. 3). It is preferred that the number of teeth 530 do not exceed the number of corresponding spaces in the light bulb. However, any number of teeth may be provided including just one tooth. The platform 526 defines a perimeter 528 of the head piece 506a that is between the first and second sides 522 and 524. The teeth 530 are preferably arranged at the perimeter 528, thereby forming an annular ring of teeth. As seen in FIG. 5, the teeth 530 may be equally spaced to substantially match the corresponding spaces of the light bulb. The teeth 530 are generally the same height and extend long enough to enter and engage the spaces of the light bulb. The teeth 530 are preferably substantially rigid such that the teeth 530 will not flex when engaging the light bulb.

The engagement member 540 opposite the teeth 530 may be a stem that is slightly shorter and smaller than the elongated stem 514 of the holder 502, thereby allowing the elongated stem 514 of the holder 502 to receive the stem 540 of the head piece 506a. In a preferred embodiment, the stems 514 and 540 releasably engage one another in a telescoping friction fit. Other releasable engagement mechanisms may use used, such as a snap or latch engagement. Although the stems 514 and 540 are shown has having a generally square cross-sectional shape, the stems 514 and 540 may have other cross-sectional shapes, such as circular, as long as one of the stems 514 or 540 can receive the other stem 514 or 540 in a telescoping manner.

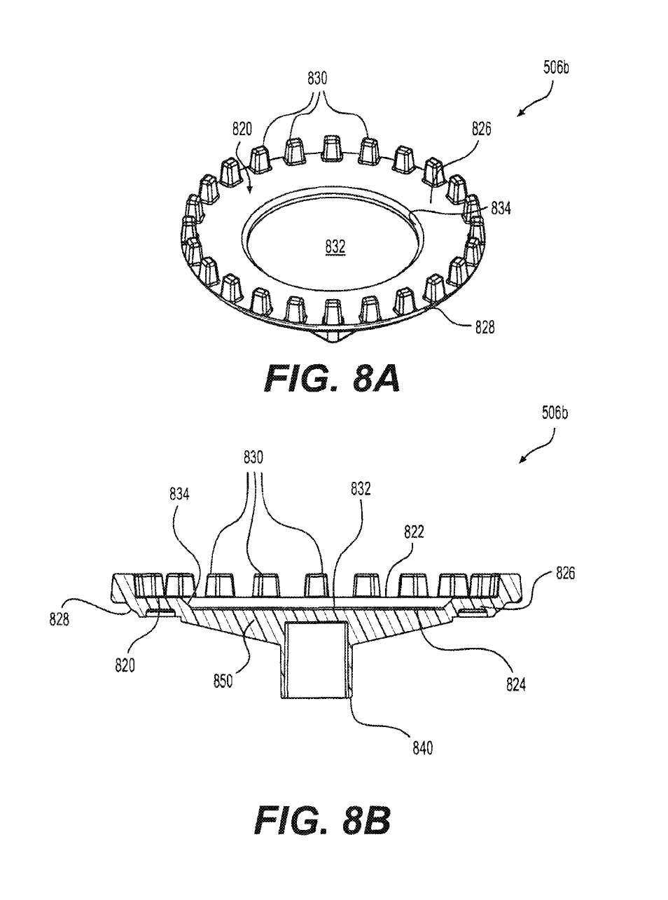

FIGS. 8A and 8B illustrate a second exemplary embodiment of the selected head piece 506b. Like the first embodiment, the head piece 506b generally includes a base plate 820 with first and second opposite sides 822 and 824, a plurality of teeth 830 extending from the first side 822, and an engagement member 840 extending from the second side 824. As best seen in FIG. 8A, the base plate 820 may optionally include a central recessed area 832 having a ledge 834, thereby defining the platform 826 for supporting the teeth 830 between the ledge 834 and the perimeter 828 of the base plate 820. The recessed area 832 is sized to accommodate any protrusion on the light bulb that may interfere with the adapter grasping the light bulb. The teeth 830 are arranged on the platform 826 at the perimeter 828 and spaced from the ledge 834. Like the teeth 530 of the first embodiment, the teeth 830 are preferably equally spaced and form an annular ring at the perimeter 828 of the base plate 820. Unlike the head piece 506a of the first embodiment, the head piece 506b of the second embodiment may include strength members 850 at its second side 824. As seen in FIG. 8B, one or more of the strength members 850, such as fins, may extend between the second side 824 of the head piece 506b and the engagement member 840.

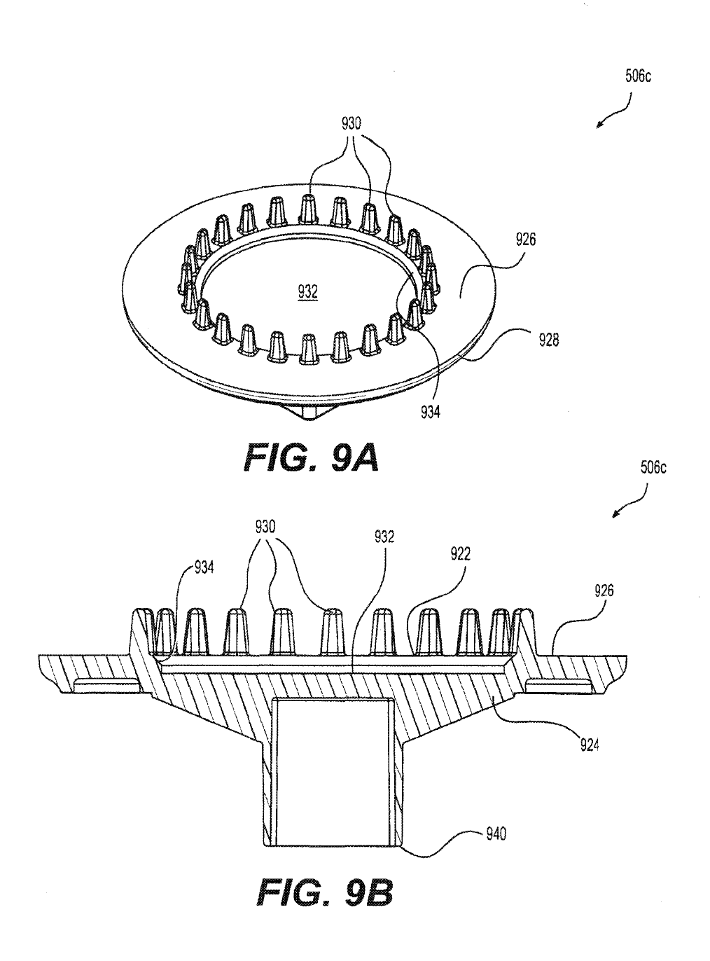

FIGS. 9A and 9B illustrate a third exemplary embodiment of the selected head piece 506c. The head piece 506c is similar to the head piece 506b, except that its teeth 930 are spaced from the perimeter 928 of the head piece. Like the head piece 506b of the second embodiment, the head piece 506c generally includes a base plate 920 where the plurality of teeth 930 extend from the base plate's first side 922, and an engagement member 940 that extends from the second side 924. And like the second embodiment, the head piece 506c of the third embodiment includes a platform 926 for the teeth 930 that is defined between a ledge 934 of an optional central recessed area 932 and the base plate's perimeter 928. Unlike the head piece 506b of the second embodiment, the teeth 930 of the third embodiment are spaced from the base plate's perimeter 928 and are preferably disposed adjacent to the ledge 934. As such, the teeth 930 may form an annular ring around the central recessed area 932, as seen in FIG. 9A.

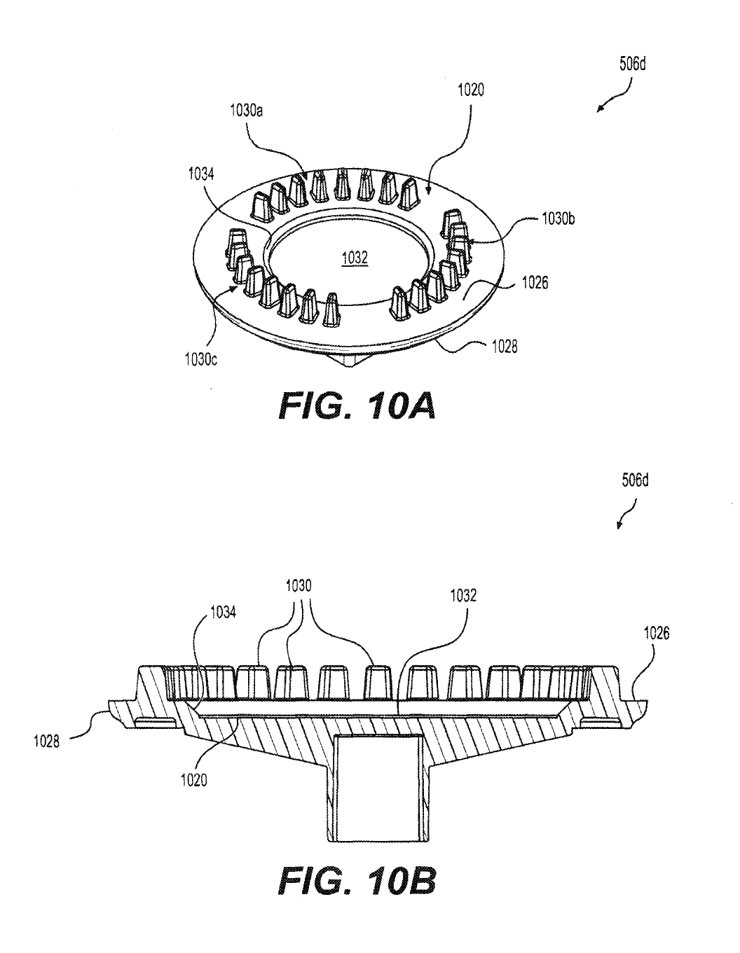

FIGS. 10A and 10B illustrate a fourth exemplary embodiment of the selected head piece 506d, which is similar to the third embodiment, except that the teeth 1030 are disposed in groups and are spaced between the ledge 1034 of the central recessed area 1032 and the perimeter 1028 of the base plate 1020. In a preferred embodiment, the teeth 1030 are provided in three groups 1030a, 1030b, and 1030c where the groups 1030a, 1030b, and 1030c are preferably equally spaced from one another on the platform 1026, as best seen in FIG. 10A. Alternatively, any number of groups of the teeth 1030 may be provided depending on the type light bulb to be grasped, including just two groups of teeth. And the number of teeth 1030 in each group 1030a, 1030b, and 1030c is preferably the same. However, the number of teeth in each group 1030a, 1030b, and 1030c may vary. In this embodiment, the groups of teeth 1030a, 1030b, and 1030c are arranged on the platform 1026 so that the teeth 1030 are spaced both from the ledge 1034 and the perimeter 1028.

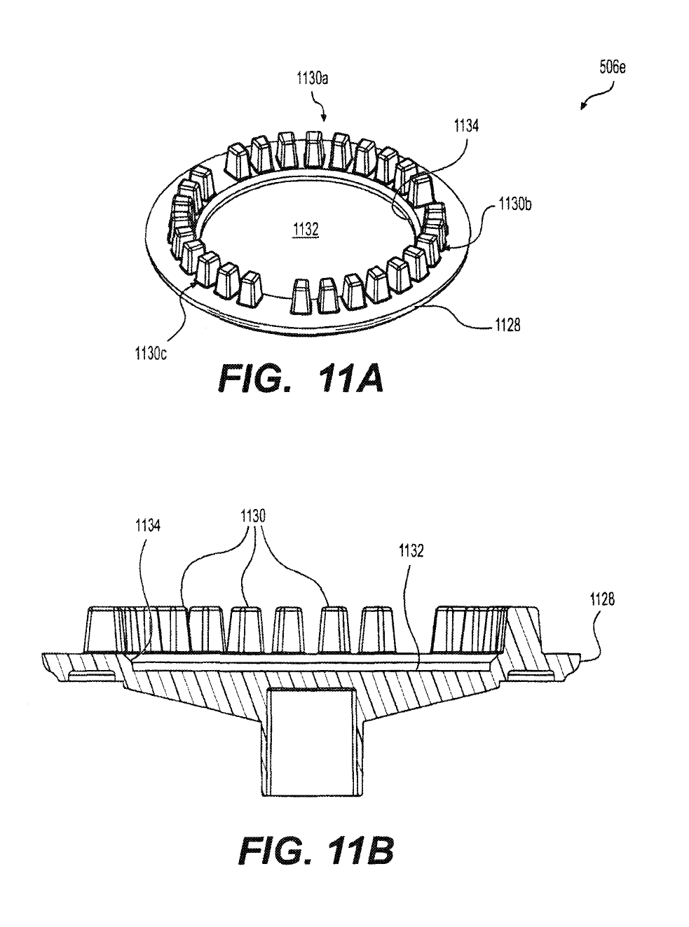

FIGS. 11A and 11B illustrate a fifth exemplary embodiment of the selected head piece 506e that is similar to the fourth embodiment, except that the teeth 1130 are located adjacent the ledge 1134 of the central recessed area 1132 and away from the base plate's perimeter 1128. Like the fourth embodiment, the teeth 1130 are preferably arranged in groups 1130a, 1130b, and 1130c; however each group of teeth 1130a, 1130b, and 1130c may have at least one more tooth than the groups 1030a, 1030b, and 1030c of the fourth embodiment.

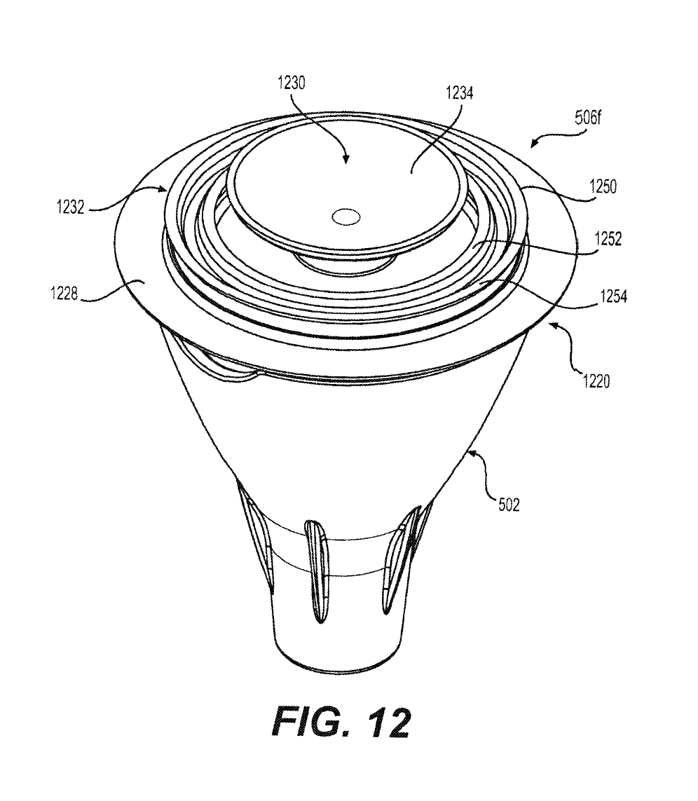

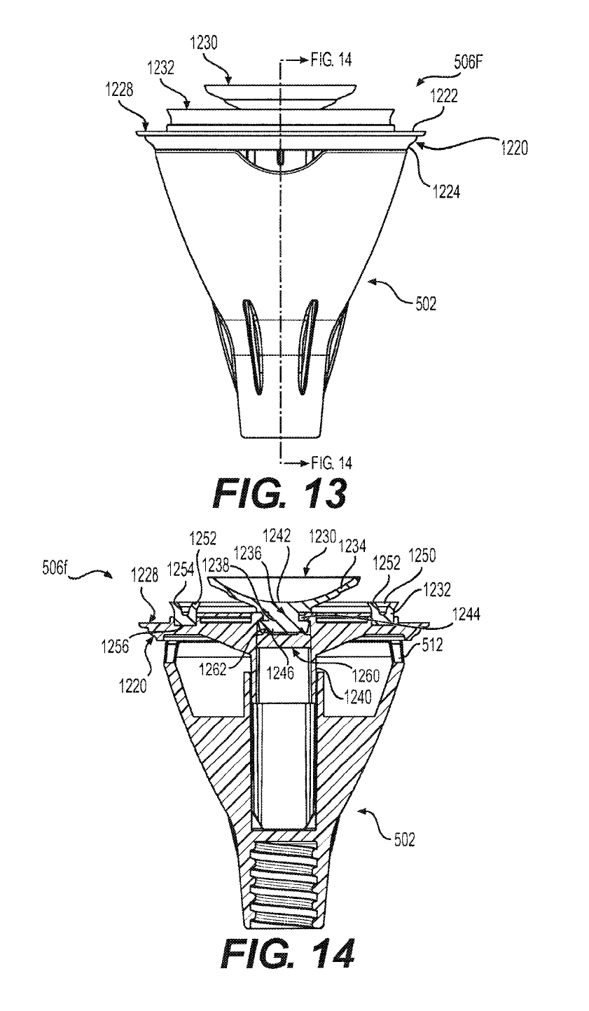

FIGS. 12-14 illustrate a sixth exemplary embodiment of a selected head piece 506f that is mountable on the holder 502. The head piece 506f includes a base plate 1220 with first and second opposite sides 1222 and 1224 and a platform 1228. Primary and secondary gripping members 1230 and 1232 extend from the platform 1228 at the first side 1222 of the base plate 1220 for securely gripping the light bulb. An engagement member 1240 extends from the second side 1224 of the base plate 1220 for engaging the holder 502.

The primary gripping member 1230 is preferably a suction cup having an open face 1234 facing away from the platform 1228. The suction cup 1230 may be positioned substantially centrally with respect to the platform 1228 to engage the light bulb. The suction cup 1230 is preferably formed of rubber to apply sufficient suction when pushed against the light bulb for gripping the light bulb. The suction cup 1230 may be formed of any material that is capable of applying suction to the light bulb. The suction cup 1230 may be releasably coupled to the platform 1228 by an attachment member 1236, as seen in FIG. 14. The attachment member 1236 may include an extension 1238 extending from a bottom 1242 of the suction cup 1230. The extension 1238 may be configured to be received in a corresponding opening 1244 of the platform 1228. At the end of the extension 1238, a flange end 1246 is provided which catches against the platform to retain the suction cup 1230. Due to the flexible nature of the suction cup 1230, it may be removed from the platform opening 1244 with sufficient pulling force and replaced with sufficient pushing force. An optional anti-rotation member 1260 may be provided in the engagement 1240, which is preferably a stem, for engaging flange end 1246 and substantially preventing rotation of the suction cup 1230. The anti-rotation member 1260 may include teeth 1262, for example, that engage the bottom of the flanged end 1246 of the suction cup 1230, as seen in FIG. 14.

The secondary gripping member 1232 is preferably a channel 1250 that includes opposing first and second grip arms 1252 and 1254 for further gripping of the light bulb. The channel 1250 may be spaced from the perimeter of the base plate 1220 and substantially surround the suction cup 1230. The channel 1250 is preferably formed of rubber to provide a friction grip between its arms 1252 and 1254 and the light bulb. The channel 1250 may be formed of any material that is capable of sufficiently gripping the light bulb. The channel 1250 has a substantially circular shape and substantially circles the suction cup 1230. The opposing first and second grip arms 1252 and 1254 may flare outwardly slightly to improve the grip on the light bulb, as seen in FIG. 14. The channel 1250 may reside in a substantially circular recessed groove 1256 formed in the platform 1228.

When using the adapter 500 with the head piece 506f of the sixth embodiment mounted thereon for changing a light bulb, the suction cup 1230 is first applied against the light bulb. The adapter is then moved or pushed toward the light bulb thereby compressing the suction cup 1230 against the light bulb to establish a suction grip of the light bulb. The adapter is pushed against the light bulb until the channel 1250 also grips the light bulb via a friction grip with the channel's grip arms 1252 and 1254. Once both the suction cup 1230 and the channel 1250 have both gripped the light bulb, the light bulb can be removed and changed. To release the light bulb from the adapter, the holder 502 is twisted and pulled with enough force to break the suction of the suction 1230 and friction grip of channel 1250.

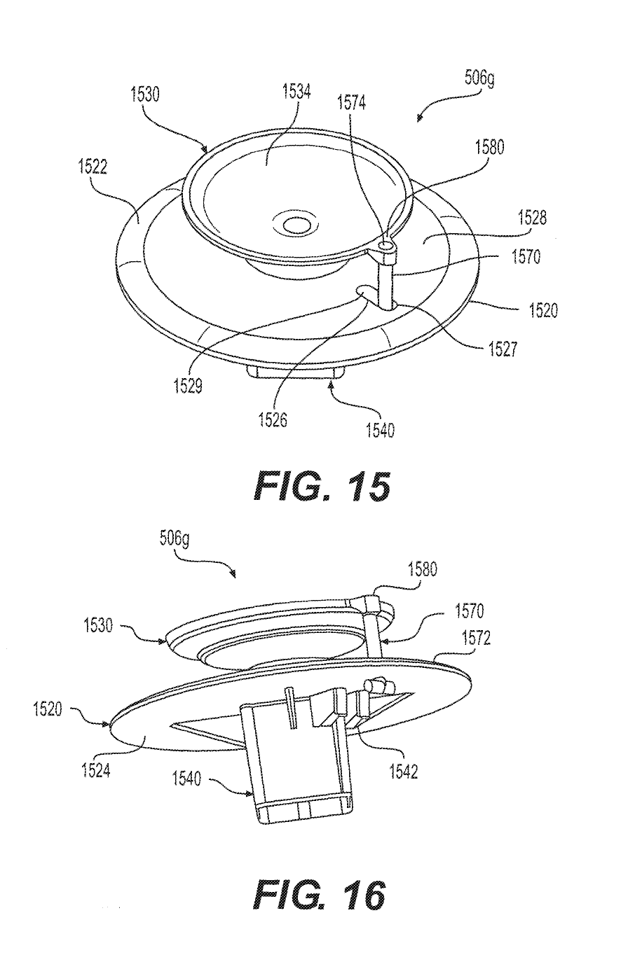

FIGS. 15-19 illustrate a seventh exemplary embodiment of a selected head piece 506g that is mountable on the holder 502. The head piece 506g includes a base plate 1520 with first and second opposite sides 1522 and 1524 and a platform 1528. A gripping member 1530 extends from the platform 1528 at the first side 1522 of the base plate 1520 for securely gripping the light bulb. An engagement member 1540 extends from the second side 1524 of the base plate 1520 for engaging the holder 502.

Similar to the sixth embodiment, the gripping member 1530 is preferably a suction cup having an open face 1534 facing away from the platform 1528. The suction cup 1530 may be positioned substantially centrally with respect to the platform 1528 to engage the light bulb. The suction cup 1530 applies suction when pushed against the light bulb for gripping the light bulb. The suction cup 1530 may be formed of any material that is capable of applying suction to the light bulb. The suction cup 1530 may be releasably coupled to the platform 1228 by an attachment member 1536, in a manner similar to the sixth embodiment above. Due to the flexible nature of the suction cup 1530, it may be removed from the platform opening 1544 with sufficient pulling force and replaced with sufficient pushing force. An optional anti-rotation member 1560 may be provided in the engagement 1540, which is preferably a stem, for substantially preventing rotation of the suction cup 1530 in a manner similar to anti-rotation member 1260 of the sixth embodiment.

Head piece 506g preferably includes at least one release member 1570 coupled to suction cup 1530 and base plate 1520 to facilitate release of head piece 506g from the light bulb. The at least one release member 1570 may be a link having an actuating end 1572, an opposite distal end 1574, and an arm portion 1576 therebetween. Actuating end 1572 may include a leg portion 1578 extending substantially transversely to arm portion 1576. The length of leg portion 1578 is preferably shorter than the length of arm portion 1576.

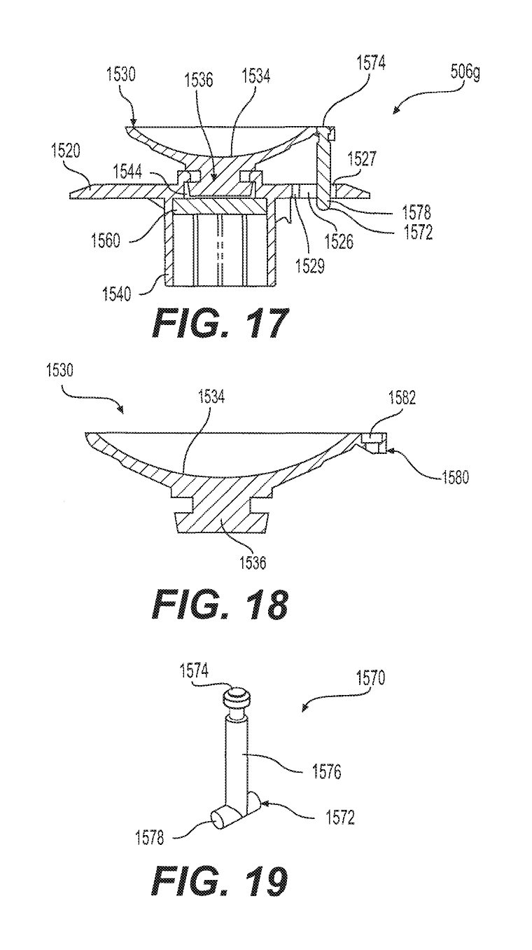

Suction cup 1530 preferably includes at least one release tab 1580 extending from a periphery thereof. The release tab 1580 may include a recess 1582 (FIG. 18) such that tab 1580 may be fitted over the distal end 1574 of link 1570. Recess 1582 is sized to receive the link's distal end 1574 and in a preferred embodiment, is sized such that the distal end 1574 of the link 1570 is recessed therein to avoid interference with the operation of the suction cup 1530, particularly the gripping of the light bulb.

Actuating end 1572 of the link 1570 extends through a slot 1526 in the base plate 1520. The slot 1526 is preferably sized to allow leg portion 1578 of link 1570 to pass therethrough and to provide freedom of movement for the link 1570 when using the head piece 506g. Slot 1526 is preferably oriented such that one end 1527 thereof is closest to the perimeter of base plate 1520 and the other end 1529 is closest to the center of base plate 1520. Link 1570, and particularly arm portion 1576, may move in slot 1526 between its ends 1527 and 1529. The stem 1540 may optionally include one or more extensions 1542 (FIG. 16) to control any movement of link 1570.

When using head piece 506g with adapter 500 for changing a light bulb, the suction cup 1530 is first applied against the light bulb and then moved or pushed toward the light bulb thereby compressing the suction cup 1530 against the light bulb to establish a suction grip of the light bulb. Once the suction cup 1530 grips the light bulb, the light bulb can be removed and changed.

To release the light bulb from the adapter and head piece 506g, the link 1570 may be actuated to release the grip of the suction cup 1530. Link 1570 may be actuated by moving base plate 1520 via holder 502 to rock or pivot the head piece. When link 1570 is actuated to release the suction cup 1530, the suction cup's release tab 1580 is pulled toward base plate 1520 via the distal end 1574 of link 1570 and base plate 1520 engages actuating end 1572 of link 1570 as the head piece is being rocked. Second side 1524 of base plate 1520, in particular, abuts leg portion 1578 of link 1570 when link 1570 is actuated. As suction cup 1530 is compressed to grip the light bulb and then released, link 1570 may move within slot 1526 of base plate 1524.

To use the interchangeable adapter 500, the user selects one of the head pieces 506a, 506b, 506c, 506d, 506e, 506f, or 506g in accordance with the size and type of light bulb to be changed. The user can then assemble the selected head piece 506 on the holder 502 by placing the selected head piece 506 on the holder's interface end 510 and coupling the engagement members 514 and 540. The engagement members 514 and 540 are configured to releasably couple, such as by a friction fit, thereby allowing the user to grasp and remove the selected head piece 506 from the holder 502 and replace it with another head piece as desired.

While preferred embodiments and variations thereof have been set forth above, those skilled in the art who have reviewed the present disclosure will readily appreciate that other embodiments can be realized within the scope of the invention. For example, the holder, head pieces, the teeth, suction cup, and channel can have any proportions that are compatible with the light bulb to be changed, and the adapter can have any compatible number of teeth. The diameter and width of the teeth may be changed in accordance with the size and type of light bulb. Additionally, the number of teeth may be selected based on the light bulb being grasped, including just one tooth. Similarly, the diameter of the suction cup and channel may be changed in accordance with the size and type of light bulb. Also, the invention can be used with an LED light bulb or any other similar device. Moreover, any shape of any component (such as the body 200, 200a, 200b, 200c, and holder 502) can be used as long as the adapter still works. Therefore, the present invention should be construed as limited only by the appended claims.

We claim:

1. A head piece for an adapter for changing a light bulb, comprising:
a base plate, said base plate having opposite first and second sides, said base plate defining a platform at said first side;
a gripping member extending from said platform of said first side of said base plate away from said second side, said gripping member being positioned substantially centrally with respect to said platform to engage the light bulb;
at least one release member linking said base plate and said gripping member wherein movement of said base plate actuates said release member; and
an engagement member extending from said second side of said base plate away from said first side for engaging a holder of the adapter.

2. A head piece according to claim 1, wherein
said gripping member is a suction cup, said suction cup has an open face facing away from said platform for gripping the light bulb.

3. A head piece according to claim 2, wherein
said at least one release member is a link extending between said suction cup and said base plate, said link including an actuating end and a distal end opposite said actuating end.

4. A head piece according to claim 3, wherein
said distal end of said link is coupled to a release tab extending from a perimeter of said suction cup.

5. A head piece according to claim 4, wherein
said release tab has a recess sized to receive said distal end of said link

6. A head piece according to claim 3, wherein
said base plate includes a slot for receiving said link.

7. A head piece according to claim 3, wherein
said link includes an arm portion extending between said distal end and said actuating end; and
said actuating end includes a leg portion extending transversely with respect to said arm portion.

8. A head piece according to claim 7, wherein
said arm portion extending through a slot in said base plate; and
said leg portion abutting said second side of said base plate when said link is actuated.

9. A head piece according to claim 8, wherein
said slot is sized to allow said leg portion of said link to pass therethrough.

10. A head piece according to claim 1, wherein
said suction cup includes an attachment member for coupling to said platform of said base plate.

11. A head piece according to claim 10, wherein
said attachment member includes an extension extending from a bottom of said suction cup, said extension is received in an opening of said platform; and
said extension including a flanged end for catching on said platform.

12. A head piece according to claim 1, wherein
said engagement member is a stem extending from said second side of said base plate away from said gripping member.

13. An interchangeable adapter for changing a light bulb, comprising:
a holder having a mounting end and an interface end opposite said mounting end, and a first engagement member disposed inside of said holder; and
at least one head piece separate from said holder and releasably coupled thereto at said interface end of said holder, said head piece including,
a base plate having opposite first and second sides, said base plate defining a platform at said first side,
a gripping member extending from said platform of said first side of said base plate away from said second side, said gripping member being positioned substantially centrally with respect to said platform to engage the light bulb,
at least one release member linking said base plate and said gripping member, wherein movement of said base plate actuates said release member to release the grip on the light bulb, and
a second engagement member extending from said second side of said base plate away from said first side for engaging said first engagement member of said holder.

14. An interchangeable adapter according to claim 13, wherein
said gripping member is a suction cup, said suction cup has an open face facing away from said platform for gripping the light bulb.

15. An interchangeable adapter according to claim 13, wherein
said at least one release member is a link extending between said suction cup and said base plate, said link including an actuating end that engages said base plate and a distal end opposite said actuating end that engages said suction cup.

16. An interchangeable adapter according to claim 15, wherein
said distal end of said link is coupled to a release tab extending from a perimeter of said suction cup; and
said actuating end extends through a slot in said base plate such that said second side of said base plate engages said actuating end when said link is actuated.

17. An interchangeable adapter according to claim 16, wherein
said link includes an arm portion extending between said distal end and said actuating end; and
said actuating end includes a leg portion extending transversely with respect to said arm portion, said leg portion abutting said second side of said base plate when said link is actuated.

18. An interchangeable adapter according to claim 13, wherein
said first and second engagement members are adapted to engage one another in a releasable friction fit.

19. A method for changing a light bulb, comprising the steps of:
providing an adapter having a holder and a head piece releasably mounted thereto, the head piece including a base plate having opposite first and second sides, the base plate defining a platform at said first side, a gripping member extending from the platform of the first side of the base plate away from said second side, the gripping member being positioned substantially centrally with respect to the platform, and at least one release member linking the base plate and the gripping member;
gripping the light bulb with the gripping member of the adapter; and
subsequent to gripping the light bulb with the gripping member, releasing the grip of the gripping member on the light bulb by actuating the at least one release member.

20. A method according to claim 19, wherein
actuating the release member includes moving the base plate by rocking the head piece.

21. A method according to claim 19, wherein
the gripping member is a suction cup extending from the first side of the base plate that grips the light bulb by suction; and
the release member is a link including a distal end coupled to a release tab at a periphery of the suction cup and an actuating end opposite the distal end coupled to the base plate.

22. A method according to claim 21, wherein
the step of releasing the suction cup includes pulling on the release tab of the suction cup via the distal end of the link when the base plate engages the actuating end of the link as the head piece is being rocked.

23. A method according to claim 22, wherein
the actuating end of the link extends through a slot in the base plate such that the second side of the base plate abuts the actuating end when the head piece is being rocked.

24. A method according to claim 23, wherein
said link includes an arm portion extending between said distal end and said actuating end; and
said actuating end includes a leg portion extending transversely with respect to said arm portion, said leg portion abutting said second side of said base plate when said link is actuated.
